(19) United States
(12) Patent Application Publication
(10) Pub. No.: US 2006/0074843 A1
(43) Pub. Date: Apr. 6, 2006

(54) World wide web directory for providing live links

(76) Inventor: Luis C. Pereira, Freehold, NJ (US)

Correspondence Address: Richard C. Litman;LITMAN LAW OFFICES, LTD., P.O. Box 15035, Arlington, VA, 22215, US

(21) Appl. No.: 10/954,080

(22) Filed: Sep. 30, 2004

(51) Int. Cl. G06F 17/30

(52) U.S. Cl. 707/1

(57) ABSTRACT

The World Wide Web directory for providing live links includes a search function whereby customers can perform a keyword search of database entries to locate websites having a live link. The search results in a listing of websites matching the customer's request, including for each website a URL for the website and its live link. In addition to searching among the database for live links, customers can submit ratings of the websites. The ratings are displayed along with the listing of websites that match a customer's request. Additionally, website or live link owners can register their websites and manage a list of keywords that will be searched by the search function. Sponsored members are members who pay a fee, or place a bid to pay a fee “per hit”, for more prominent ranking among search results. Websites that don't have a live link are given the lowest priority.

### BACKGROUND OF THE INVENTION

1. Field of the Invention

The present invention relates to World Wide Web searching on the Internet. More specifically, the present invention is a World Wide Web directory for providing live links to enable a user to locate a World Wide Website, such as an online business, offering real-time online interaction with a human representative.

2. Description of the Related Art

The World Wide Web represents a primary technology for enabling electronic commerce and communications on the Internet. Within the topology of the World Wide Web, also referred to simply as “the Web”, or “WWW”, numerous computer systems are linked together by the Internet. The computer systems function in the roles of client systems and server systems, or both. Server systems host Websites that provide content, including text, images, animation, video, sound, and other types of multimedia. Client systems typically include a client software component known as a “browser” that provides a graphical user interface through which a user can access the content available from server systems.

In addition to client/server interactions, the Internet and the Web facilitate communications between individual users, where users at remote locations can use their computers, or another Internet compatible device, to communicate with one another. Special Web services provide “chat room” functions where users interact through a server, exchanging text messages through a public or potentially multi-user medium. A “chat room” may provide an open forum shared by many parties to a discussion, or an exclusive interaction between two parties. Peer-to-peer connections allow users to communicate, across the Internet, directly, using the Internet to establish a “direct connection” between the users' computers. In addition to textual communications, voice-over-internet protocol (VoIP) voice communications between users connected across the Internet.

Web pages and content, and requests for web pages and content, are exchanged across the Internet with a Web-compatible protocol such as the Hyper Text Transfer Protocol (HTTP). Web pages and content are transferred, by the HTTP, generally in the form of files that are identified by a Uniform Resource Locator (URL). The web pages and content typically include hypertext documents, written HyperText Markup Language (HTML) or another format that facilitates hypertext linking, such that the web pages and content may include hyperlinks that reference URLs for other web pages and content.

The amount of information, including web pages and content, that is available on the Web has grown to staggering proportions. Given that, to access any individual web page or content item, a URL, or a hyperlink that references the URL, for the individual web page or content item must be known or available to a user. Thus, a problem exists for users who wish to find information on the Web that relates to a particular subject or category. For instance, a user that wants to find, on the Web, information about “computers” must find the URLs for various websites and content that relate to “computers.”

Web searching services are provided by specialized Websites that help people to find information stored on other sites, making the job of finding information about a particular subject among the hundreds of millions of web pages easier. Web based “search engines” and “web directories” provide the ability for a user to enter various keywords and perform a search among vast numbers of web pages and content to find web pages and content related to the entered keywords. While search engines and web directories both help users in locating information, a fundamental difference exists in that search engines typically use automated programs to search and index web pages on the Internet, while web directories typically use human actors to manually review, select, and categorize web pages on the Internet.

A number of different search services (AltaVista, AskJeeves, Excite, Google, InfoSeek, Northern Light, and more) use different techniques to try to match a user's request to the most relevant web pages and content. Various difficulties may be encountered with the various techniques in properly interpreting the user's search request, or in narrowing the scope of the search to produce listings that are most relevant while eliminating those that are not very relevant or entirely irrelevant. Problems arise as a result of contextual interpretation of search terms, interpretation of words in a search request that may have multiple meanings, and other complexities of language.

These problems are compounded when a user's search request seeks to couple two or more different aspects of a search into a single request. For example, where a user wishes to search for websites and content that relate to computers, and also have an additional feature such as a live link to chat or speak with a customer service representative, a web search may return results that relate to one or the other aspect, but not both.

Web pages are often maintained by businesses, wherein a business's web page essentially represents an electronic store front. There is currently an increasing trend among businesses to offer, on their web page, the feature of real-time online interaction with a live person, such as a customer service representative. Businesses benefit if their customers perceive improved customer service and more personalized service, and customers that use a business's website are likely to perceive improved customer service and more personalized service if their website experience includes the option of such a live interaction.

However, while customers rely on conventional search engines to identify and locate business websites that offer such a feature, problems described with conventional search engines may frustrate the desire of both the customers, who wish to find websites for a particular type of business offering real-time online interaction, and the businesses, who wish to have their websites more prominently listed for the customers who seek their services. Additionally, once such a website is found for a business that provides for live interaction with a representative of the business, it generally is necessary to navigate first to the business website, and then find a link for the live interaction on the business website for further navigation.

Consequently, there is a need for a searchable web directory that lists websites that have an associated live link providing real-time live interaction with a website representative, along with a direct reference to the live link. Thus a World Wide Web directory for providing live links solving the aforementioned problems is desired.

### SUMMARY OF THE INVENTION

The World Wide Web directory for providing live links is a searchable web directory providing directory entries for websites that include a facility for real-time interaction between a customer and a human representative of the website.

Numerous websites on the Internet include a facility for a real-time live interaction with a human actor, or with a computerized or other simulation or modeling that creates the appearance of a human actor. Such real-time live interactions include text-based chat, video conferencing, and audio communications such as VoIP. A URL for connecting a user with a real-time live interaction is referred to herein as a “live link.”

World Wide Web directory for providing live links includes a database that contains entries for websites that have a live link. Included in the entry for each website is the live link.

Users of the World Wide Web directory for providing live links can be categorized in two groups. Customers are the users who use the World Wide Web directory for providing live links to search for websites that relate to a particular subject of interest to the customer. Members are users who have a website that is registered, or that they would like to register, within the database for access by customers.

The World Wide Web directory for providing live links includes a search function whereby customers can perform a keyword search of the database entries to locate the websites, and their live links, relating to a particular subject. The search results in a listing of websites that match the customer's request, the listing including for each website a URL for the website and its live link. In addition to using the World Wide Web directory for providing live links to search among the database for websites that include a live link, customers can submit ratings of the websites. The ratings are displayed along with the listing of websites that match a customer's request.

Additionally, the World Wide Web directory for providing live links includes an administrative function where members can register their websites and manage a list of keywords that will be searched by the search function. Website owners that haven't yet registered their website become members by providing information about their website that includes a URL for their website and a live link, along with a description of the website and one or more search keywords. Members are further categorized as regular members or sponsored members. Sponsored members are members who pay a fee, or place a bid to pay a fee “per hit”, to have their website positioned more prominently among websites that match a particular search request. Regular members pay no fees, and their websites are ranked with equal priority, except that websites that don't have a live link are given the lowest priority.

These and other features of the present invention will become readily apparent upon further review of the following specification and drawings.

### BRIEF DESCRIPTION OF THE DRAWINGS

FIG. 1 is block diagram of a computer network system implementing a World Wide Web directory for providing live links according to the present invention.

FIG. 2 is a block diagram of a computer system in which the World Wide Web directory for providing live links operates according to an embodiment of the present invention.

FIGS. 3, 4, and 5 are a flowchart depicting the operation of the World Wide Web directory for providing live links in an administrative mode wherein website owners register and manage their website listings within the World Wide Web directory for providing live links.

FIG. 6 is a screen shot of a form generated by the World Wide Web directory for providing live links for registration of website listings.

FIG. 7 is a screen shot of a form generated by the World Wide Web directory for providing live links for management of website listings.

FIG. 8 is a block diagram of a website listing entry in a database of website listings maintained by the World Wide Web directory for providing live links.

FIG. 9 is a flowchart depicting the operation of the World Wide Web directory for providing live links in a search mode wherein customer users submit search requests to the World Wide Web directory for providing live links to locate websites related to their search request.

FIG. 10 is a screen shot of a search entry web page generated by the World Wide Web directory for providing live links.

FIG. 11 is a screen shot of a search results web page generated by the World Wide Web directory for providing live links in response to a customer search request.

FIG. 12 is a flowchart depicting a process for requesting and receiving customer feedback relating to a visited website.

Similar reference characters denote corresponding features consistently throughout the attached drawings.

### DETAILED DESCRIPTION OF THE PREFERRED EMBODIMENT

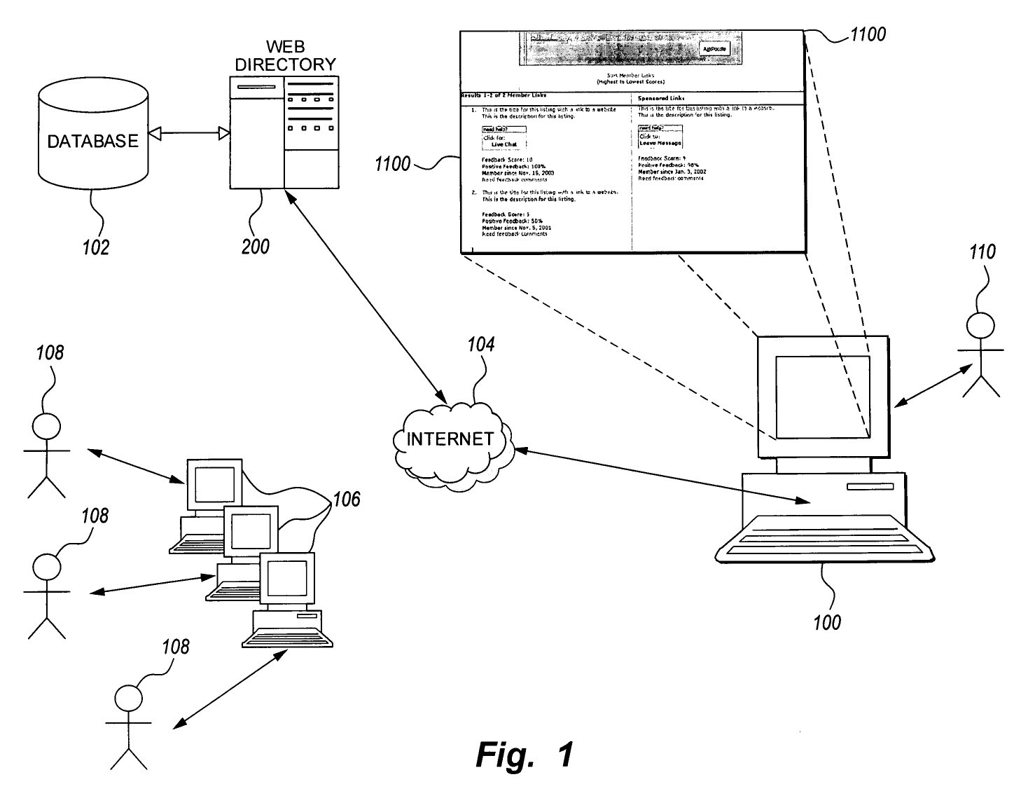

The present invention is a World Wide Web directory for providing live links. Referring to FIG. 1, the World Wide Web directory for providing live links is, in the illustrated embodiment, implemented by a computer program executing on a server computer 200, the server computer 200 being connected to the Internet 104. The computer program is essentially a web server type of program that generates web page views for display by a client program, such as a Web browser, running on a client computer such as a customer computer 100 or a live-link hosting computer 106, and services requests generated by and received from user interaction with the client program.

The World Wide Web directory for providing live links maintains a database 102 that contains listings for websites that have a facility for a live real-time interaction with a human actor, or with a computerized or other simulation or modeling that creates the appearance of a human actor. Such real-time live interactions include text-based chat, video conferencing, and audio communications such as VoIP. A URL for connecting a user with a real-time live interaction is referred to herein as a “live link.” Live-link hosting computers 106 are in connection with the Internet 104, and are equipped with peripheral devices that facilitate live textual, audio, or video interactions so that a human actor 108 or a simulation can conduct, through a live-link hosting computer 106, a live real-time interaction through the Internet 104 and a customer computer 100 with a customer 110.

Customers 110, using a customer computer 100, access the World Wide Web directory for providing live links to present a search request and receive search results that include a listing of websites with live links. The search results generated by the World Wide Web directory for providing live links are received and displayed by the client program to display a search results web page 1100 that is displayed on the customer computer 100. The results web page 1100 includes hyperlinks that reference live links that the customer 110 may use to reach a live-link hosting computer 106 and engage in a live real-time interaction with a human actor 108.

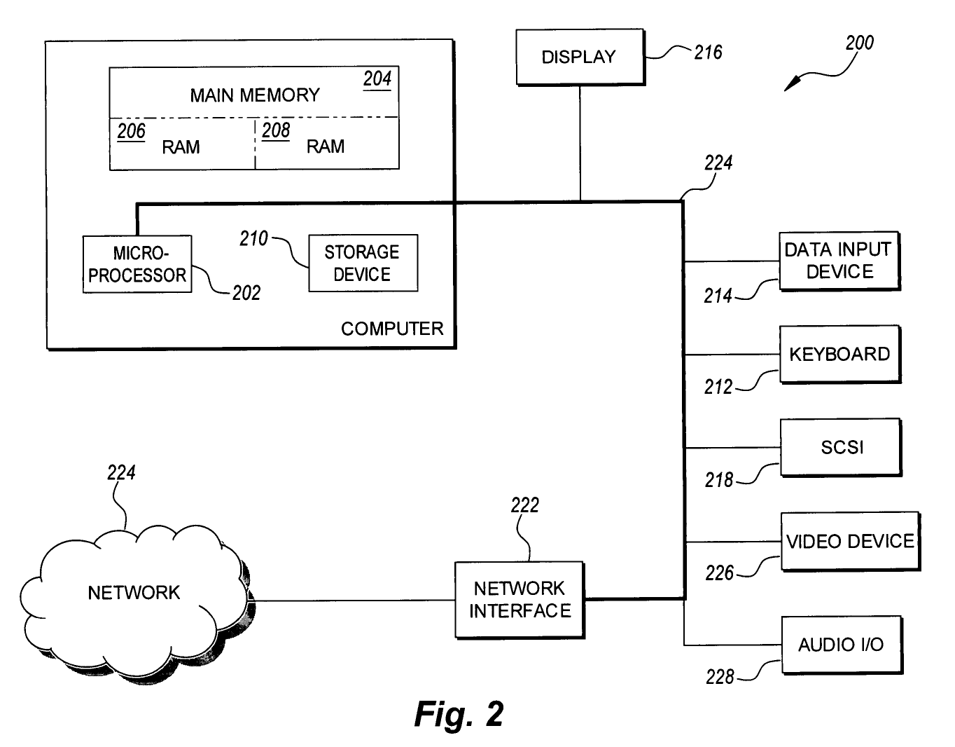

Referring to FIG. 2, the server 200 is a general purpose or personal computer of a generally known and common configuration. Server 200 has a microprocessor 202 connected by a bus 224 to an area of main memory 204, comprising both read only memory (ROM) 208, and random access memory (RAM) 206, and a storage device 210 such as a disk storage device having means for reading a coded set of program instructions on a computer readable medium which may be loaded into main memory 204 and executed by the microprocessor 202. The server 200 has a display device 216, a keyboard 212, and may include one or more other input devices 214 such as a mouse, joystick, etc. A network communication interface 222 is provided for serial communications on a network 224 or other serial communications link. The network communication interface 222 may provide more than a single communication channel so that the server 200 may communicate, for example, on both a local area network (LAN) and the Internet 104. The server 200 may include a video device 226, such as a web cam, and an audio IO device 228 capable of supporting voice I/O. Additionally, the server 200 may include a Small Computer System Interface (SCSI) adapter 218 for communication with peripheral devices. The customer computer 100 and the web hosting computers 106 are generally of the same, or of a similar, configuration as the server 200, as will be understood by one of skill in the art, except the customer computer 100 and the web hosting computers 106 may also include a video device 226, such as a web cam, or an audio IO device 228 capable of supporting voice I/O, or both, to facilitate live audio or video interactions.

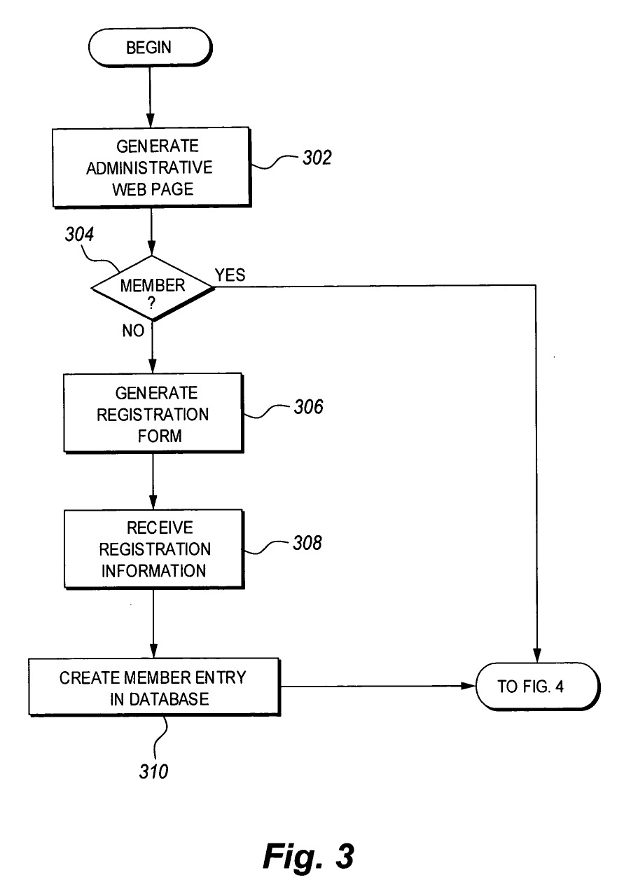

Turning now to FIG. 3, the computer program implementing the World Wide Web directory for providing live links on the server 200 includes processes whereby an owner or administrator of a website having a facility for a live real-time interaction can register their website with the World Wide Web directory for providing live links, thereby creating an entry in the database 102, or can modify a previously created entry.

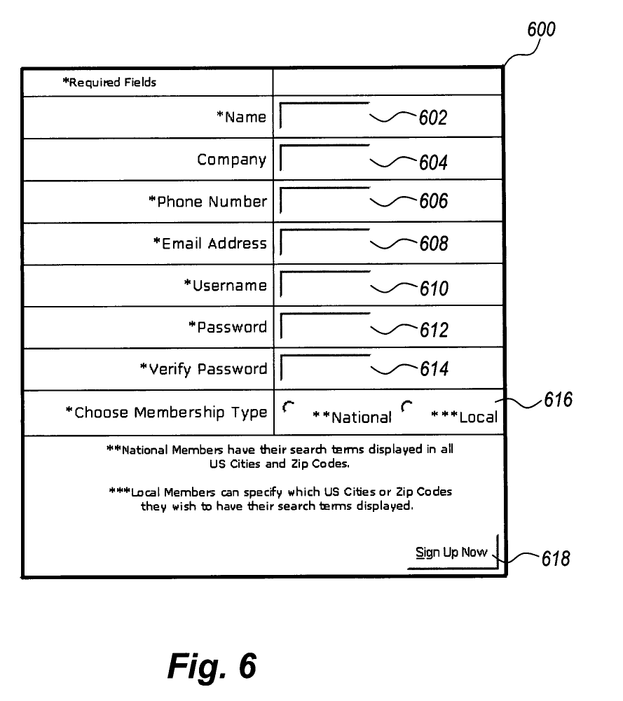

The computer program generates an administrative web page (step 302), displayable by a client program running on a client computer connected to the Internet 104, such as a live-link hosting computer 106. The administrative web page presents a user with the option to sign on as a member, or to register to become a member. A member is, simply, a party who has registered a website with the World Wide Web directory for providing live links. If the user has selected to register a website to become a member (decided at step 304), the computer program generates a registration form 600, seen in FIG. 6 (step 306). The registration form has data entry fields for a name 602, the name 602 being typically an owner or representative of a website, a company 604 operating the website, and contact information such as a phone number 606 and email address 608. Additionally, a username afield 610 and a password field 612, along with a password verify field 614, allow a registering member to enter validating information in the form of a username and password to identify the member for future accesses. Additionally, the registration form 600 includes a selection field 616 that allows selection of a national listing or a local listing membership type. A button 618 on the registration form 600 causes a client program displaying the registration form 600 to forward the information entered into the entry fields to the server 200. Some of the entry fields may be designated as required, such that the registration form information will not be forwarded to the server until all required fields are filled in.

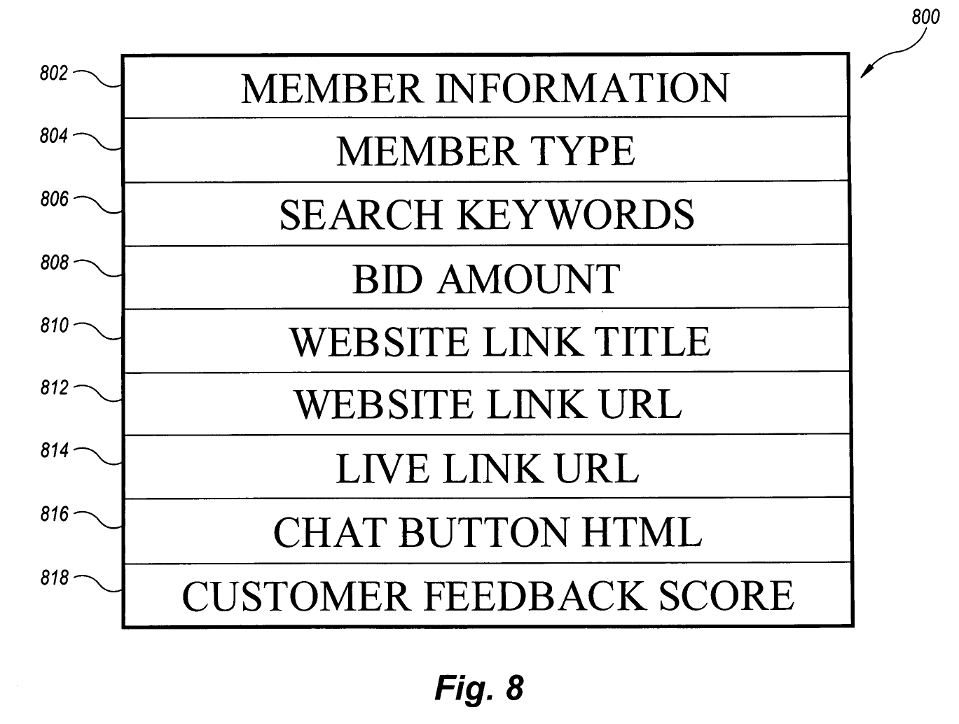

The computer program receives the registration information (step 308) and uses the registration information to create a new member listing 800 (shown in FIG. 8) in the database 102 (step 310). Referring briefly to FIG. 8, a member listing 800 contains a data field for storing member information 802, the member information including name, company, contact information, and the like. The member listing includes additional data fields for member type 804, search keywords 806, a bid amount 808, a title 810 and URL 812 for the website, a live link 814, and a chat button HTML code 816 for creation of a customized hyperlink for the live link 814. Additionally, the member listing includes a data field for storing customer rating information such as a customer feedback score 818. The function of the data fields will be more clearly understood as the computer program is described more completely.

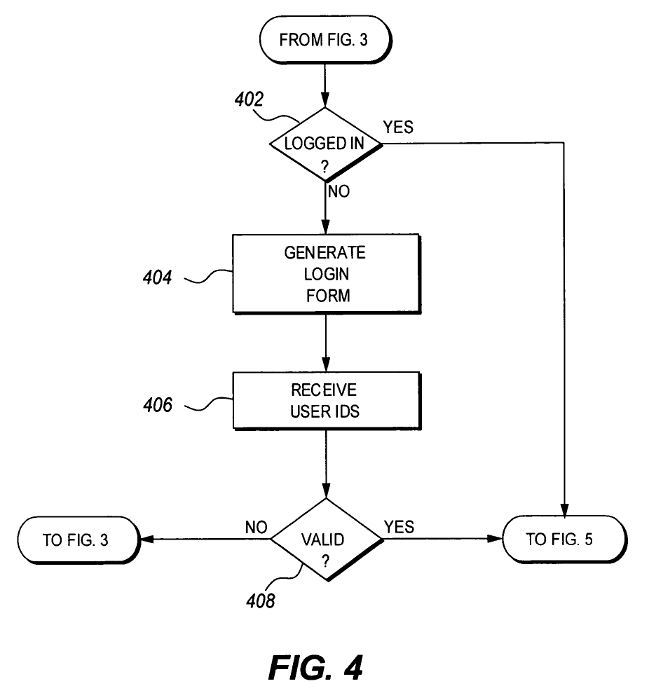

Turning now to FIG. 4, the computer program includes a process for logging in members prior to allowing access to update a member listing. In a process familiar to those skilled in the art, if a member is not yet logged in for use of the system (decided at step 402), a login form is generated (step 404). The login form contains data entry fields for a username and an associated password. On receipt of the username and associated password (step 406), the username and password are compared to entries in the database for validation. If a valid username and password combination is entered (decided at step 408) the member is allowed access to the member's member listing 800 to update various data fields within the member listing 800. Otherwise, the member may be returned to the administrative web page to begin again, at step 302.

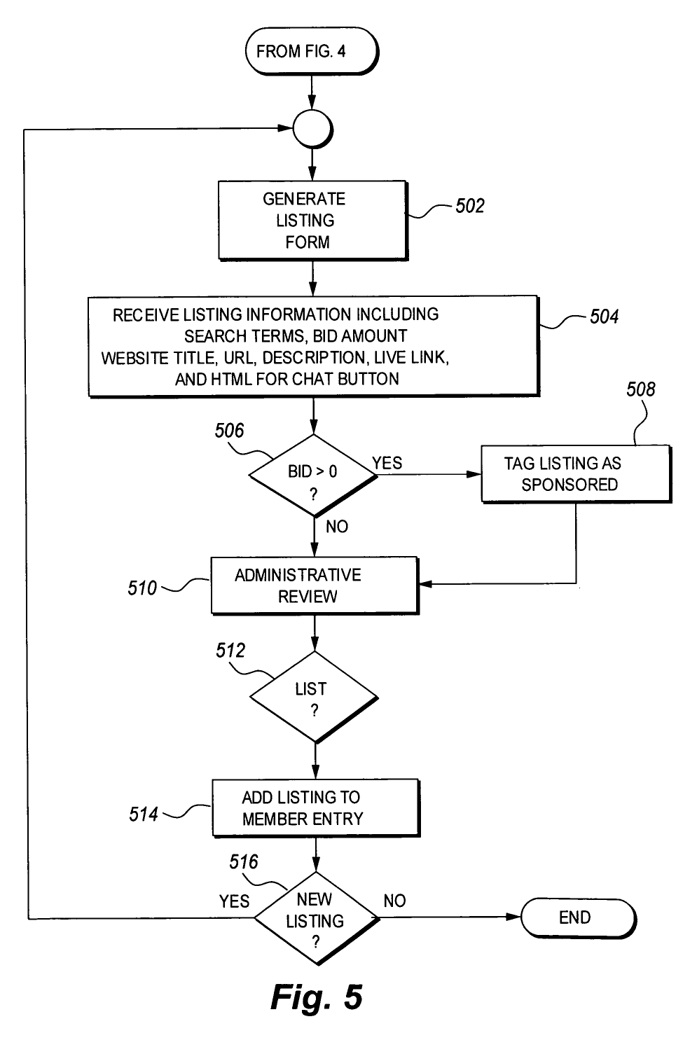

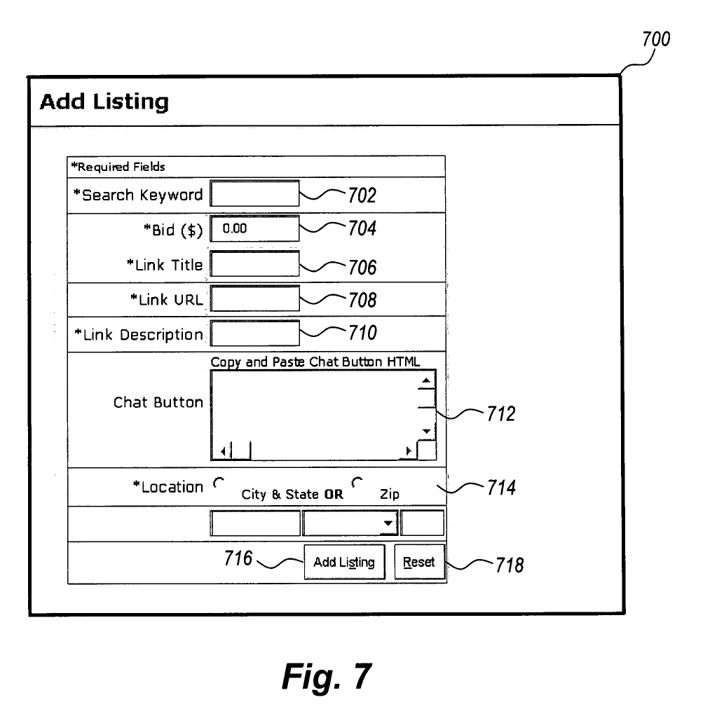

Turning now to FIG. 5, the computer program includes a process for providing members the ability to update the member listing 800 for a website, or to add a new listing 800. The computer program generates a listing form 700 (shown in FIG. 7), at step 502. The listing form 700 includes an entry field for search keywords 702, wherein a member may enter or modify a list of keywords that are stored in the member listing 800 and that will be used to match member listings 800 with a customer search request. The listing form 700 also includes an entry field for a bid amount 704. The member may leave the bid amount 704 blank (or $0.00), or may enter an amount that the member is willing to pay every time the member's listing is identified in the results to a customer search request. If the bid amount 704 is left blank (or $0.00), the member is designated a regular member. If the member enters an amount, the member is designated a sponsored member. The distinction between a regular member and a sponsored member relates to how member listings are ranked and listed in response to a customer search request, and will be discussed more fully below.

The listing form 700 also includes an entry field for a live link title 704 URL 708, and description 710. Additionally, the listing form 700 has a text entry box 712 wherein HTML code is inserted to describe a customized button for accessing the live link. The listing form 700 may include one or more entry fields (not shown) for entry of a title, URL, and description for a website associated with the live link. Location entry fields allow the member to enter the state and city, or zip code, to be used for customer search requests that designate a relevant location.

A button 716 on the listing form 700 causes a client program displaying the listing form 700 to forward the information entered into the entry fields to the server 200, along with a request to add a new listing. Some of the entry fields may be designated as required, such that the listing form information will not be forwarded to the server until all required fields are filled in. The listing form 700 may also include a button (not shown) to forward the information entered into the entry fields to the server 200, along with a request to modify a current listing, instead of adding a new listing. A reset button 718 clears all of the entry fields.

Returning to FIG. 5, at step 504 listing information is received by the computer program. If the bid amount 704 is not blank (or greater than $0.00) (decided at step 506) the listing is tagged as a sponsored listing (step 508), otherwise the listing is designated a regular listing. The listing information may then be presented for administrative review and approval prior to entering the listing into the database (step 510). The administrative review may involve the subjective or objective decision of a human administrator, based on the perceived quality of the listing, the content of the listing, or other factors. Alternatively, the administrative review may be performed automatically by the computer program by employing word search of filtering or other techniques to identify desirable or offensive characteristics of the listing. If the administrative review results in the decision to list the member listing (decided at step 512), the member listing is added into the database 102, or an existing listing modified or updated. With the listing added (or modified or updated), the member may continue and add or modify another listing (returning to step 502), or may terminate the process.

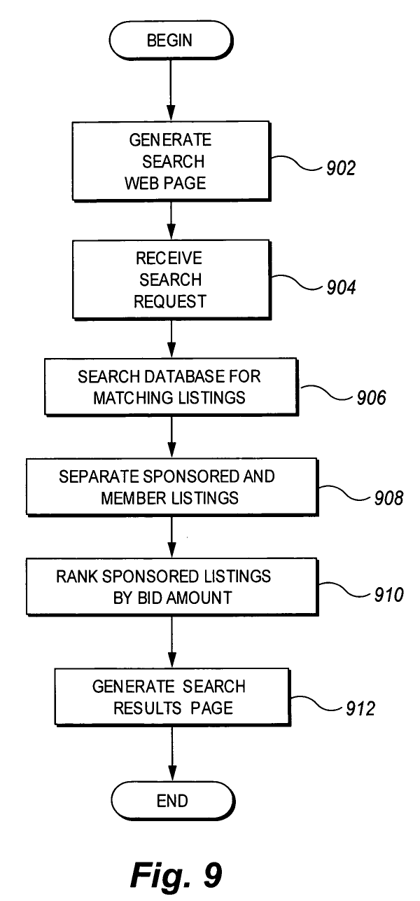

Turning now to FIG. 9, the computer program implementing the World Wide Web directory for providing live links on the server 200 includes processes whereby a customer 110 can submit a search request and receive, in response to the search request, a listing of website and live link entries that relate to the customer search request.

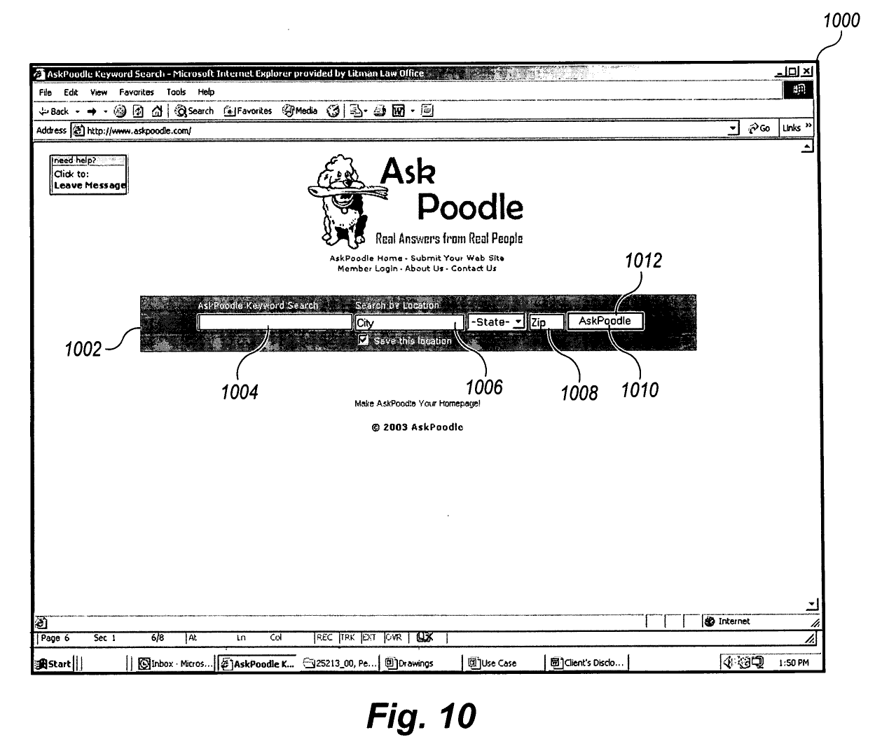

At step 902, the computer program generates a search web page 1000 (seen in FIG. 10). The search web page 1000 includes a search entry field 1002, which contains a search keywords entry field 1004, and location entry fields including city 1006 and state 1008 entry fields and a zip code entry field 1010. A button 1012 in the search web page 1002 causes a client program displaying the search web page 1002 to forward the search request to the server 200.

Returning to FIG. 9, the computer program receives the search request (step 904). The database 102 is searched for entries that correspond to the search request, using any of numerous search techniques that are well known to those of skill in the art (step 906). The search identifies member listings 800 with search keywords 806 that match the search keywords provided in the search request. Additionally, the member listings 800 are selected according to location information included in the search request. Once appropriately matching member listings 800 are identified, sponsored member listings 800 and regular member listings 800 are separated. Sponsored member listings 800 are ranked according to the bid amount 808 of each of the sponsored member listings 800 (step 910). Regular member listings 800 are ranked according to a non-prioritizing ranking criteria, such as a randomized or rotating prioritization, that gives all of the regular member listings equal priority except that any listings that don't have a live link are give a lowest priority.

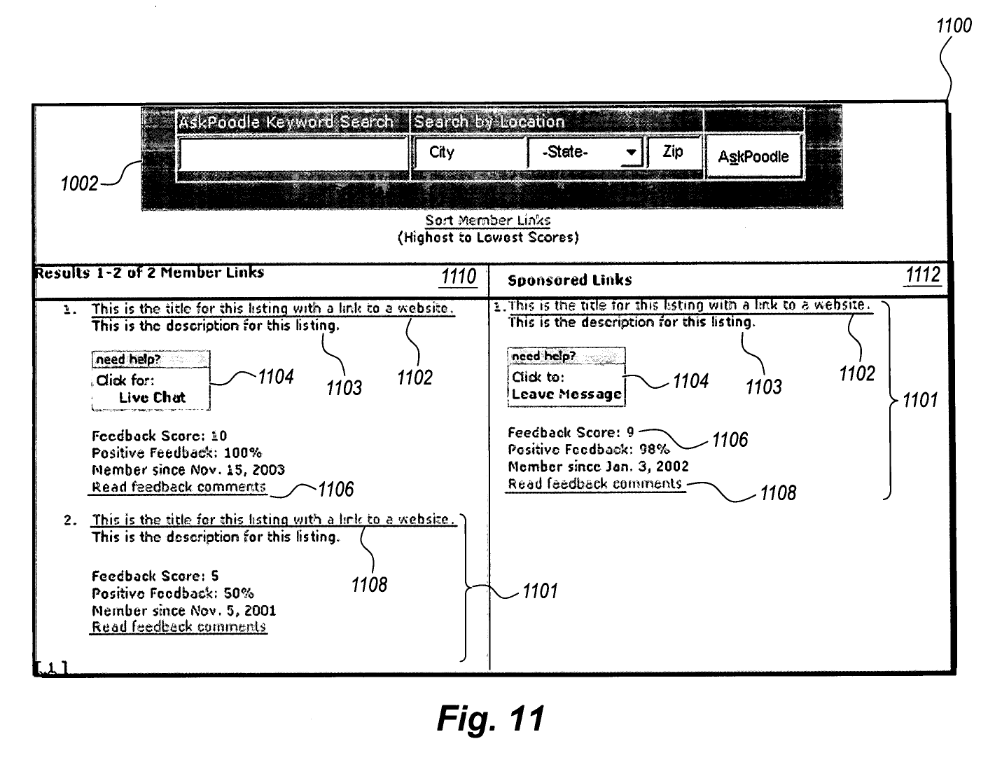

A search results page 1100 (shown in FIG. 11) is generated to display the sponsored and regular member listings according to their respective ordering criteria. The search results page 1100 includes the search entry field 1002, so that a customer 110 can enter another search request. The member listings 800 are shown as display listings 1101, displayed in a column 1110 of regular member display listings 1101 and a column 1112 of sponsored member display listings 1101. The display listings 1101 within each column are ordered according to the respective ordering criteria of their respective member listings 800.

Each of the display listings 1101 includes a hyperlink 1102 and a description 103 for the listing, and a customized button 1104, based on the chat button HTML 816, for accessing the live link 814. The display listings 1101 also include customer feedback information 1106, as well as a hyperlink 1108 to access and read customer comments. A customer 110 may click on the customized button 1104 navigate to the live link to begin a live real-time interaction with live real-time interaction with a human actor 108 at a live-link hosting computer 106.

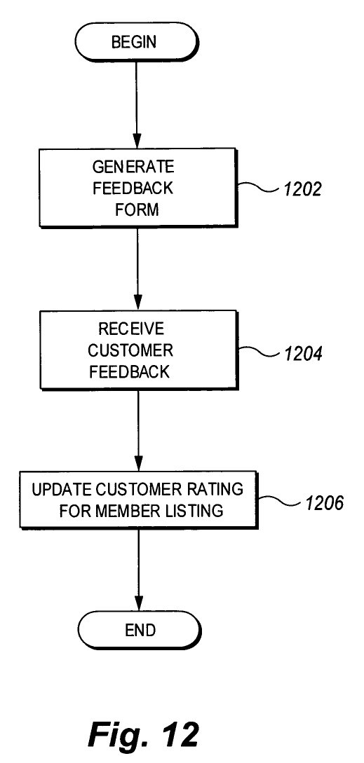

Turning now to FIG. 12, the computer program implementing the World Wide Web directory for providing live links on the server 200 includes a process whereby a customer 110 can submit feedback or rating information relating to member listings 800. The computer program generates a feedback form (step 1202) that has entry fields wherein a customer 110 can enter remarks, enter a score or satisfaction rating, or provide additional objective or subjective evaluation and review of the website, live link or other services obtained through a member listing 800. The computer program receives information provided by customer 110 (step 1204) and updates the customer feedback score 818 in the member listing 800 (step 1206).

It is to be understood that the present invention is not limited to the embodiment described above, but encompasses any and all embodiments within the scope of the following claims.

I claim:

1. A computerized system for providing a World Wide Web directory for providing live links, comprising:
a server having a processor, an area of main memory for executing program code under the direction of the processor, a storage device for storing data and program code, a network interface connecting the server to the Internet, and a bus connecting the processor, the main memory, the storage device, and the network interface;
at least one database in communication with said server, the database containing a plurality of member listings, each member listing including a live link and at least one search keyword;
a computer program stored in said storage device and executing in said main memory under the direction of said processor, the computer program including:
means for generating a search web page;
means for receiving a search request including at least one search keyword;
means for retrieving from said database a results set of member listings relating to said search request; and
means for generating a search results web page containing, for each member listing in said results set, a display listing having a hyperlink referencing the member listing's live link.

2. The computerized system for providing a World Wide Web directory for providing live links according to claim 1, wherein said computer program further comprises means for adding additional member listings to said database.

3. The computerized system for providing a World Wide Web directory for providing live links according to claim 2, wherein said means for adding additional member listings to said database includes means for generating at least one web page form for entry of member listing information.

4. The computerized system for providing a World Wide Web directory for providing live links according to claim 2, wherein said means for adding additional member listings to said database includes means for entering said at least one search keyword.

5. The computerized system for providing a World Wide Web directory for providing live links according to claim 1, wherein said computer program further comprises means for modifying said member listings.

6. The computerized system for providing a World Wide Web directory for providing live links according to claim 5, wherein said means for modifying member listings to includes means for generating at least one web page form for editing member listing information.

7. The computerized system for providing a World Wide Web directory for providing-live links according to claim 5, wherein said means for modifying member listings includes means for modifying said at least one search keyword.

8. The computerized system for providing a World Wide Web directory for providing live links according to claim 1, wherein each said member listing further includes a chat button code for generating a customized hyperlink referencing with said live link.

9. The computerized system for providing a World Wide Web directory for providing live links according to claim 8 wherein said means for generating a search results web page includes means for including in each said display listing a customized button for accessing said live link.

10. The computerized system for providing a World Wide Web directory for providing live links according to claim 1, wherein each said member listing includes a bid amount.

11. The computerized system for providing a World Wide Web directory for providing live links according to claim 10, wherein said means for generating a search results web page includes means for ranking said display listings according to said bid amounts.

12. The computerized system for providing a World Wide Web directory for providing live links according to claim 10, wherein said computer program further comprises means for designating a member listing as a sponsored listing if it's bid amount is greater than zero, and designating a member listing as a regular listing if it's bid amount is not greater than zero.

13. The computerized system for providing a World Wide Web directory for providing live links according to claim 12, wherein said means for generating a search results web page includes means for distinguishing said sponsored listings from said regular listings.

14. The computerized system for providing a World Wide Web directory for providing live links according to claim 13, wherein said means for generating a search results web page includes means for ranking said sponsored listings according to said bid amounts and ordering said regular listings according to a non-prioritized ranking.

15. A computerized method for providing a World Wide Web directory for providing live links, comprising the steps of:
storing a plurality of member listings in a database, wherein each member listing includes at least one search keyword and at least one URL referencing either a live link or a website;
generating a search request web page;
receiving a search request including at least one search keyword;
retrieving from said database a results set of member listings relating to said search request;
generating a prioritized ordering of said member listings within said results set to give member listings having a URL referencing a live link a higher priority than member listings having a URL referencing a website; and
generating a search results web page containing, for each member listing in said results set, a display listing having a hyperlink referencing said URL, the display listings being displayed according to said prioritized ordering.

16. The computerized method for providing a World Wide Web directory for providing live links according to claim 15, wherein each said member listing includes a bid amount.

17. The computerized method for providing a World Wide Web directory for providing live links according to claim 16, wherein said prioritized ordering gives a member listing with a higher bid amount priority over a member listing having a lower bid amount.

18. The computerized method for providing a World Wide Web directory for providing live links according to claim 16, wherein a member listing is designated a sponsored listing if its bid amount is greater than zero, and is designated a regular listing if its bid amount is not greater than zero.

19. The computerized method for providing a World Wide Web directory for providing live links according to claim 18, wherein display listings on said results web page are organized into a set of sponsored display listings and a set of regular display listings.
